(19) United States
(12) Patent Application Publication
(10) Pub. No.: US 2018/0087896 A1
(43) Pub. Date: Mar. 29, 2018

(54) A METHOD FOR MEASURING THE DIAMETER AND/OR THE GEOMETRY OF THE DIAMETER OF A CYLINDRICAL OBJECT, A MEASUREMENT SYSTEM AND A USE OF THE MEASUREMENT SYSTEM

(71) Applicant: PR ROLLS OY, Parhalahti (FI)

(72) Inventors: Jukka PIRTTINIEMI, Helsinki (FI); Esa PORKKA, Nurmes (FI)

(73) Assignee: PR ROLLS OY, Parhalahti (FI)

(21) Appl. No.: 15/568,168

(22) PCT Filed: Apr. 22, 2015
(86) PCT No.: PCT/FI2015/050281

§ 371 Date: Oct. 20, 2017

(51) Int. Cl. G01B 11/10; G01P 3/36; D21F 11/06

(52) U.S. Cl. CPC G01B 11/105; D21F 11/06; G01P 3/36

(57) ABSTRACT

The present invention relates to a method for measuring the diameter and/or the geometry of the diameter of a cylindrical object. The cylindrical object has a longitudinal axis and a cylindrical shell. The method comprises measuring in a contactless manner at a specific point in the direction of the longitudinal axis the momentary circumferential velocity of the cylindrical shell at specific time or the distance which the circumference of the cylindrical shell rotates, measuring revolutions of the cylindrical shell or the angle of rotation of the cylindrical shell simultaneously with the measuring of the momentary circumferential velocity at specific time or the distance which the circumference of the cylindrical shell rotates, and calculating the diameter of the cylindrical shell and/or the geometry of the diameter of the cylindrical shell at the specific point in the direction of the longitudinal axis. The present invention also relates to a measurement system for measuring the diameter and/or the geometry of the diameter of a cylindrical object and the use of the measurement system.

### BACKGROUND OF THE INVENTION

The present invention relates to a method for measuring the diameter and/or the geometry of the diameter of a cylindrical object, the cylindrical object having a longitudinal axis and a cylindrical shell. The present invention also relates to a measurement system and a use of the measurement system.

The drawbacks of the current measurement systems and methods are that the cylindrical objects, such as dryer cylinders or rolls of paper machines or paperboard machines, shall be moved to another location in order to make required maintenance actions, such as grinding of the surface of the cylindrical object. The cylinder or roll shall be decoupled from the paper or paperboard machine and it shall be transported, for example, to a roll grinding machine. This is time consuming and it wastes resources. Further, the cylinders or rolls are not in the same temperature as during operation. Thus, the diameter or the geometry of the cylinder or the roll may be different in different conditions, which leads to the fact that it is very challenging to grind in such a manner that the result is also acceptable in the operating conditions on the paper or paperboard machine.

It is also known to make measurements in the operating conditions but those measurements are often based on measuring with a measuring tape. The measurements may be erroneous or inaccurate, and usually only the end areas of the cylindrical object are measured leaving the middle of the object without attention. Due to the measurement errors, the maintenance may generate high costs.

In order to attain more precise measurement results in the operating conditions, some measurement methods have been developed. In those methods, the cylindrical object to be measured is in contact with the measuring device. The contact with the cylindrical object causes problems which increase the inaccuracy of the measurement and thus, the benefits of the above mentioned methods are questionable.

Further, there are also contactless methods. They are usually based on multiple sensors whose function together is complicated, inaccurate and very challenging in on site conditions.

### BRIEF DESCRIPTION OF THE INVENTION

The aim of the invention is to develop a method using an accurate measurement system which can be applied in normal operating conditions and in a normal place of operation. Thus, the heat expansion, the elastic deformation and the vibrations which exist in the normal operating conditions are all taken into account in the method of the invention. However, the normal operating conditions and the normal place of operation, i.e. on site conditions, are the most challenging conditions and therefore, it is natural that the invention can be applied in other conditions which may be less demanding.

The method of the invention is characterized in that that the method comprises
measuring in a contactless manner at a specific point in the direction of the longitudinal axis the momentary circumferential velocity of the cylindrical shell at specific time or the distance which the circumference of the cylindrical shell rotates,
measuring revolutions of the cylindrical shell or the angle of rotation of the cylindrical shell simultaneously with the measuring of the momentary circumferential velocity at specific time or the distance which the circumference of the cylindrical shell rotates, and
calculating the diameter of the cylindrical shell and/or the geometry of the diameter of the cylindrical shell at the specific point in the direction of the longitudinal axis.

The method of the invention can be applied to, for example, dryer cylinders and rolls of paper machines and paperboard machines. Further, the method of the invention can also be applied to riding rings of rotary kilns and their shell or diameter changes. More specifically, the method of the invention can be used for evaluating deformations on the surface of the cylindrical shell and according to this evaluation the need for grinding can be assessed.

The cylindrical object means in this text an object which has a longitudinal axis and a cylindrical shell symmetrically around it, ie. in the cross section of the cylindrical object the longitudinal axis is in the middle of the circular cross section of the shell. Such objects are, for example, the dryer cylinders and rolls of the paper and paperboard machines. However, the method of the invention can be applied in connection with any rotating cylindrical object.

The term “on site” means in this text that the operation takes place in a normal operation site of the cylindrical object, i.e. the cylindrical object is not removed anywhere from its normal place of operation.

The method is useful in determining the cross sectional geometry of the cylindrical shell. For example, diameter changes caused by crowning, centrifucal force or heat expansion can be determined by this method. The method comprises measuring the momentary circumferential velocity of the cylindrical shell at specific time or the distance which the circumference of the cylindrical shell rotates in a contactless manner at a specific point in the direction of the longitudinal axis, measuring revolutions of the cylindrical shell or the angle of rotation of the cylindrical shell simultaneously with the measuring of the momentary circumferential velocity at specific time or the distance which the circumference of the cylindrical shell rotates, and calculating the diameter and/or the geometry of the cylindrical object. The above mentioned measurements may take place on site.

The momentary circumferential velocity of the cylindrical shell at specific time or the distance which the circumference of the cylindrical shell rotates is measured in a contactless manner. Suitable devices for such measurements are velocimeters whose measurement system is based on laser or visible light. However, the measurement device can be different but it must be capable of measuring the above mentioned parameters.

The measurement takes place at a specific point in the direction of the longitudinal axis. In other words, the measuring device is immobile during a single measurement so that the momentary circumferential velocity at specific time or the distance which the circumference of the cylindrical shell rotates is measured only from one specific location. The measurement is repeated at several specific points in the direction of the longitudinal axis in order to obtain information about the diameter and/or the geometry throughout the circumference of the shell. The measurements can also take place simultaneously, i.e. several measurements can take place at the same time in different specific points in the direction of the longitudinal axis.

Simultaneously with the measurement of the momentary circumferential velocity at specific time or the distance which the circumference of the cylindrical shell rotates, revolutions of the cylindrical shell or the angle of rotation of the cylindrical shell are measured. A trigger sensor, an inclinometer, a pulse transducer or the like can be used in the measurement. One benefit of the invention is that the speed of rotation can change without causing any troubles in the measurement. The measurement of the angle of rotation makes it possible to synchronize the measurement results into the same angle and thus, accurate results can be achieved irrespective of variations in the speed of rotation. The both above-mentioned measurements shall be performed at high frequency.

After the measurements, the diameter of the cylindrical object and/or the geometry of the cylindrical object is calculated by using, for example, the following equations.

$$D = \frac{L}{π {n}_{rev}} tai D = \frac{\int v ( t ) dt}{π {n}_{rev}} ,$$

wherein

D=diameter of the cylindrical object,

L=distance which the cylindrical shell rotates,

nᵣₑᵥ=revolutions which the cylindrical shell rotates,

v=momentary circumferential velocity at specific time t

t=time

$$D = \frac{2 {v}_{average }}{{ω}_{average}} ,$$

wherein

D=diameter of the cylindrical object,

v_{average}=average momentary circumferential velocity, ω_{average}=average angular speed

If the measurement is made by a sensor which gives pulses as an output, another manner to calculate the length of the circumference is available. The pulses can be analyzed by the zero-crossing or the level-crossing techniques. The analysis gives directly the number of the pulses of the sensor in a certain period, for example a period of hundred revolutions. The pulses per one rotation can be calculated by dividing the number of the pulses by the number of the revolutions. As the frequency of the sensor is known the length of the circumference can be calculated directly. The accuracy of the measurement can be enhanced by further signal processing.

Besides the diameter of the cylindrical object, the geometry of the circumference of the cylindrical object can also be determined. By analyzing changes of the momentary circumferential velocity the local deformations of the shell can be analyzed. A recession on the surface of the cylindrical shell decreases the circumferential velocity although the speed of rotation is constant. A protrusion, for one, increases the circumferential velocity. Thus, the local geometry can be detected.

### EXAMPLE

A Yankee cylinder of a paper machine requires maintenance due to the unevenness of the shell of the cylinder. In order to assess the need for grinding, a measurement system is installed beside the Yankee cylinder, i.e. the Yankee cylinder remains in its normal place of operation and the measurement takes place on site. The rotating speed may be the normal process speed.

The measurement system comprises a laser velocimeter and a trigger sensor. The momentary circumferential velocity at specific time or the angular speed is measured by the laser velocimeter in a contactless manner. The distance between the surface of the cylindrical shell may be, for example, 250-350 mm. The laser velocimeter may be a velocimeter using the Laser Doppler Principle to evaluate the laser light scattered back from a moving object. The revolutions of the cylindrical shell or the angle of rotation of the cylindrical shell are measured by the trigger sensor.

First, the measurement is accomplished before the maintenance in order to get information about the diameter or the geometry of the cylindrical shell. The grinding process of the shell of the Yankee cylinder is planned according to those results. The measurements can also take place during the maintenance. After the maintenance the cylinder is rotated in a normal operation speed, and the measurements are repeated at different locations in the direction of the longitudinal axis of the cylinder so that it is sure that everything is in order.

1. A method for measuring the diameter and/or the geometry of the diameter of a cylindrical object, the cylindrical object having a longitudinal axis and a cylindrical shell, said method comprising the steps of:
measuring in a contactless manner at a specific point in the direction of the longitudinal axis the momentary circumferential velocity of the cylindrical shell at specific time or the distance which the circumference of the cylindrical shell rotates;
measuring revolutions of the cylindrical shell or the angle of rotation of the cylindrical shell simultaneously with the measuring of the momentary circumferential velocity at specific time or the distance which the circumference of the cylindrical shell rotates; and
calculating the diameter of the cylindrical shell and/or the geometry of the diameter of the cylindrical shell at the specific point in the direction of the longitudinal axis.

2. The method according to claim 1, wherein the momentary circumferential velocity of the cylindrical shell at specific time or the distance which the circumference of the cylindrical shell rotates, and revolutions of the cylindrical shell or the angle of rotation of the cylindrical shell, are measured on site.

3. The method according to claim 1, wherein the momentary circumferential velocity of the cylindrical shell at specific time or the distance which the circumference of the cylindrical shell rotates is measured by using a velocimeter based on laser or visible light.

4. The method according to claim 1, wherein revolutions of the cylindrical shell or the angle of rotation of the cylindrical shell is measured by using a trigger sensor, an inclinometer or a pulse transducer.

5. A measurement system for measuring the diameter and/or the geometry of the diameter of a cylindrical object, the cylindrical object having a longitudinal axis and a cylindrical shell, the system comprising:
a unit for measuring the momentary circumferential velocity of the cylindrical shell at specific time or the distance which the circumference of the cylindrical shell rotates; and
a unit for measuring revolutions of the cylindrical shell or the angle of rotation of the cylindrical shell.

6. The measurement system according to claim 5, wherein a unit for measuring the momentary circumferential velocity of the cylindrical shell at specific time or the distance which the circumference of the cylindrical shell rotates comprises a velocimeter based on laser or visible light.

7. The measurement system according to claim 5, wherein a unit for measuring revolutions of the cylindrical shell or the angle of rotation of the cylindrical shell comprises a trigger sensor, an inclinometer or a pulse transducer.

8. A method comprising the step of using the measurement system of claim 1 in determining grinding requirement of a surface of a cylindrical object.

9. The method according to claim 8, wherein the cylindrical object is a dryer cylinder or a roll of a paper or paperboard machine.

10. The method according to claim 8, wherein the cylindrical object is a rotary kiln comprising riding rings.

11. The method according to claim 8, wherein the cylindrical object is a Yankee cylinder of a paper machine.

12. The method according to claim 2, wherein the momentary circumferential velocity of the cylindrical shell at specific time or the distance which the circumference of the cylindrical shell rotates is measured by using a velocimeter based on laser or visible light.

13. The method according to claim 2, wherein revolutions of the cylindrical shell or the angle of rotation of the cylindrical shell is measured by using a trigger sensor, an inclinometer or a pulse transducer.

14. The method according to claim 3, wherein revolutions of the cylindrical shell or the angle of rotation of the cylindrical shell is measured by using a trigger sensor, an inclinometer or a pulse transducer.

15. The measurement system according to claim 6, wherein a unit for measuring revolutions of the cylindrical shell or the angle of rotation of the cylindrical shell comprises a trigger sensor, an inclinometer or a pulse transducer.

16. The use according to claim 9, wherein the cylindrical object is a Yankee cylinder of a paper machine.
